(19) United States
(12) Patent Application Publication
(10) Pub. No.: US 2008/0098345 A1
(43) Pub. Date: Apr. 24, 2008

(54) Accessing extensible markup language documents

(76) Inventor: Tom Messina, Raleigh, NC (US)

Correspondence Address: HOLLAND & KNIGHT LLP, 10 ST. JAMES AVENUE, 11th Floor, BOSTON, MA, 02116-3889, US

(21) Appl. No.: 11/544,330

(22) Filed: Oct. 9, 2006

(51) Int. Cl. G06F 9/44

(52) U.S. Cl. 717/104

(57) ABSTRACT

Methods and apparatus, including computer program products, for accessing extensible markup language (XML) documents. A method includes enabling an array syntax within an object-oriented programming language to retrieve data from an extensible markup language (XML) document, the array syntax including defined object types, a tag name of an individual child element of a parent element object, and a name of a selected attribute within the tag name of the individual child element.

### BACKGROUND

The present invention relates to data processing by digital computer, and more particularly to accessing extensible markup language (XML) documents.

Reliable information access mechanisms in a multi-user environment are a crucial, technical issue for almost all systems that a user builds.

Most business information systems manage data that must be saved. The data must live, or “persist,” between invocations of any particular application or program. Persistence is the capability to permanently store this data in its original or a modified state, until an information system purposely deletes it. Relational databases, object databases, or even flat files are all examples of persistent data stores.

A key issue frequently encountered in the development of object-oriented systems is the mapping of objects in memory to data structures in persistent storage. When the persistent storage is an object-oriented database, this mapping is quite straightforward, being largely taken care of by the database management system.

In the more common situation, where the persistent storage is a relational database, there is a fundamental translation problem or a so-called “impedance mismatch.” The physical logical, and even philosophical differences between a relational and object data storage approach are significant. Mapping between the two is difficult. The architecture must, in this case, include mechanisms to deal with this impedance mismatch.

The impedance mismatch is due to the following contrasting features of objects/classes and tables:

Identity: Objects have unique identity, regardless of their attributes. Tables rely on the notion of primary key to distinguish rows. While a relational database management system (DBMS) guarantees uniqueness of rows with respect to primary keys for data stored in the database, the same is not true for data in memory.

Inheritance: This is a meaningful and important notion for classes; it is not meaningful for tables in traditional relational database management systems (RDBMSs).

Navigation: The natural way to access and perform functions on objects is navigational, i.e., it entails following references from objects to other related objects. By contrast, relational databases naturally support associative access, i.e., queries on row attributes and the use of table joins.

Object-oriented technology supports the building of applications out of objects that have both data and behavior. Relational technologies support the storage of data in tables and manipulation of that data using data manipulation language (DML) internally within the database using stored procedures and externally using structured query language (SQL) calls.

Impedance mismatch exists because the object-oriented paradigm is based on proven software engineering principles while the relational paradigm is based on proven mathematical principles. The underlying paradigms are different and the two technologies do not work together seamlessly. The impedance mismatch becomes apparent when one looks at the preferred approach to access. With the object paradigm one traverse objects using their relationships whereas with the relational paradigm one joins the data rows of tables. This fundamental difference results in a non-ideal combination of object and relational technologies.

An impedance mismatch between generic .NET programming languages and extensible markup language (XML) data is very high. This causes extra development costs and requires high programming skill to efficiently program high performance processing functionality for XML data. Existing methods and programming models for accessing XML data rely upon processing models that use standards such as Xpath, a language for addressing parts of an XML document, and Xquery, a query language. These models include the Document Object Model (DOM). DOM, a programming interface specification developed by the World Wide Web Consortium (W3C), lets a programmer generate and modify hypertext markup language (HTML) pages and XML documents as full-fledged program objects. DOM lacks a programmatic definition ability to quickly find an element or attribute based solely upon its XML name.

### SUMMARY

The present invention provides methods and apparatus, including computer program products, for accessing extensible markup language documents.

In general, in one aspect, the invention features a method including enabling an array syntax within an object-oriented programming language to retrieve data from an extensible markup language (XML) document, the array syntax including defined object types, a tag name of an individual child element of a parent element object, and a name of a selected attribute within the tag name of the individual child element.

In embodiments, the object-oriented programming language can be .NET.

The method can include appending naming metadata as a governed sequence number to differentiate between duplicate element tag names. The governed sequence number within an element can include a value in a range 1 to a highest value of a signed 32-bit integer.

The array syntax can be represented by a unified modeling language (UML) model. The UML model can include an element entity representing an XML element, an attribute entity representing an XML attribute, an attribute list entity representing a list of XML attributes, and an element list entity representing a list of XML elements.

The element entity can include a set of signatures that describes properties and functions that the object-oriented programming language uses to manipulate XML data. The attribute entity can include a name representing a physical name of an attribute and a value representing a value of the attribute. The attribute list entity can support an ILIST< > generic interface defined by a .NET library. The element list entity can support an ILIST< > generic interface defined by a .NET library.

In another aspect, the invention features a method including receiving and parsing extensible markup language (XML) data to an instantiated element object, the instantiated element object assuming a role of a parent element to a root element of the received XML data and returning the root element of the XML data as a newly instantiated element, the parsing including applying additional naming metadata to each element in a form of governed sequence numbers that qualify each child element within any given parent element.

In embodiments, the method can include organizing two lists of child elements for each parent element, a first list representing a sequential arrangement of elements in the received XML data and a second list including a hash table for fast look-up using a qualified name.

The qualified name can include an original element tag name and a governed sequence number. The governed sequence number can include a value in a range 1 to a highest value of a signed 32-bit integer.

The invention can be implemented to realize one or more of the following advantages.

A method leverages programming syntax in object-orientated programming languages such as .NET languages to access random individual XML data elements and attributes without employing querying techniques such as Xpath or Xquery or traversing sequential lists of elements, thereby reducing the number of skill sets required to produce effective applications.

The method results in increased processing speed and programming language efficiency.

One implementation of the invention provides all of the above advantages.

Other features and advantages of the invention are apparent from the following description, and from the claims.

### BRIEF DESCRIPTION OF THE DRAWINGS

FIG. 1 is a block diagram of an exemplary data processing system.

FIG. 2 is a block diagram of an exemplary unified modeling language (UML) model.

FIG. 3 is a flow diagram.

Like reference numbers and designations in the various drawings indicate like

### DETAILED DESCRIPTION

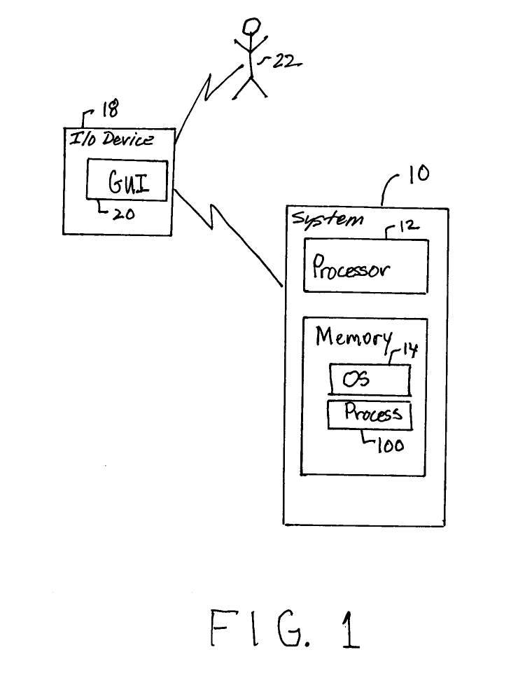

As shown in FIG. 1, an exemplary system 10 includes a processor 12 and memory 14. Memory 14 includes an operating system (OS) 16, such as Linux, Unix or Windows®, and a process 100 for accessing eXtensible Markup Language (XML) document data from object-orientated programming languages such as Microsoft® .NET framework programming languages using array lookup syntax. The system 10 also includes an input/output (IO) device 18 for display of a graphical user interface (GUI) 20 to a user 22.

Process 100 reduces an impedance mismatch between XML data and .NET generic programming languages. .NET is a Microsoft Corporation system of a runtime environment and program libraries sufficient to support a programming model. Typical methods and programming models for accessing XML data rely upon processing models that use standards such as “Xpath” and “Xquery.” These models include the Document Object Model (DOM). DOM is a programming interface specification developed by the World Wide Web Consortium (W3C). DOM enables a programmer to generate XML documents as full-fledged program objects. XML is a way to express a document in terms of a data structure. As program objects, such documents are able to have their contents and data “hidden” within the object, helping to ensure control over who can manipulate the document. As objects, documents can carry with them object-oriented procedures called methods.

XPath is a language that describes a way to locate and process items in XML documents by using an addressing syntax based on a path through the document's logical structure or hierarchy. XQuery is a specification for a query language that enables a user or programmer to extract information from an XML file or any collection of data that can be “XML-like.”

One deficiency in DOM is its lack of programmatic definition ability to quickly find an element or attribute based solely upon its XML name. Process 100 solves this deficiency by applying specific naming metadata where needed within programmatic element structures to enable a programmatic solution for the generic .NET languages.

Process 100 uses the fewest possible lines of programming code to accomplish an accurate retrieval of data from an XML document. Due to the free-flowing nature of XML data, process 100 employs fast search and lookup for XML elements and attributes.

Process 100 is accessible from all .NET languages in the form of the standard array syntax used by each individual language. For example, in the C#.NET language, the following syntax can be used to access an attribute within an element of an XML document:

MyAttribute = RootElement|“MyElement”|.Attributes|“foo”|;
where:
“MyAttribute” is an example of a defined object type capable of
supporting the syntax
“RootElement” is a defined object type capable of supporting the syntax
“MyElement” is the tag name of an individual child element of the parent
element object “RootElement.”
“foo” is the name of a given attribute within the element with the tag
name “MyElement”

Within a given XML element child, element tag names can be duplicated provided that the definition or schema of the given XML document enables it. If duplicate names exist, process 100 differentiates between equal element tag names by appending naming metadata in the form of a governed sequence number. For example, the following XML sequence contains duplicate element tags within the same parent element:

```
<ParentElement>
    <ChildElement>this is a child element</ChildElement>
    <ChildElement>this is a second duplicate child
    element </ChildElement>
</ParentElement>
```

To access the first element, the following C#.NET syntax is used:

MyElement=ParentElement|“ChildElement_{—}1”|;

And subsequently the second duplicate element may be accessed with the following C#.NET syntax:

MyElement=ParentElement|“ChildElement_{—}2”|;

The governed sequence number is controlled by process 100 and is reset on an element-by-element basis. For each duplicate name within a given element, the governed sequence number begins at one and ends at the highest positive value for a signed 32-bit integer or 2,147,483,647.

For example, consider the following XML data:

```
<ParentElement>
    <ChildElement>
        <ChildElement>this is a grandchild of
        ParentElement</ChildElement>
        <ChildElement>this is a grandchild of
        ParentElement</ChildElement>
    </ChildElement>
    <ChildElement>
        <ChildElement>this is a grandchild of
        ParentElement</ChildElement>
    </ChildElement>
</ParentElement>
```

The following element list is represented:
ParentElement
ParentElement.ChildElement_{—}1
ParentElement.ChildElement_{—}1.ChildElement_{—}1
ParentElement.ChildElement_{—}1.ChildElement_{—}2
ParentElement.ChildElement_{—}2
ParentElement.ChildElement_{—}2.ChildElement

Note that the final “ChildElement” within “ChildElement_{—}2” does not have a governed sequence number because it is unique within ChildElement_{—}2.

XML data is supplied to process 100 to an instantiated element object. The instantiated element object assumes the role of parent element to the root element of the supplied XML data and returns the root element of the XML data as an newly instantiated element. Child elements of this new root element may or may not exist depending on the content of the XML data. Attributes in the root element or child elements may or may not exist also depending on the content of the XML data. The XML data is parsed using parsing objects supplied by the .NET library.

During parsing, additional naming metadata is applied to each element in the form of governed sequence numbers that qualify each child element within any given parent element. The governed sequence number is called a qualifier during the parsing phase. When process 100 is completed the child elements for each parent element are organized in two lists. A first list represents a sequential arrangement of the elements as they exist in the original XML data. A second list is a hash table that is used for fast lookups of elements using a qualified name. The qualified name includes the original element tag name and the governed sequence number applied to the element during process 100.

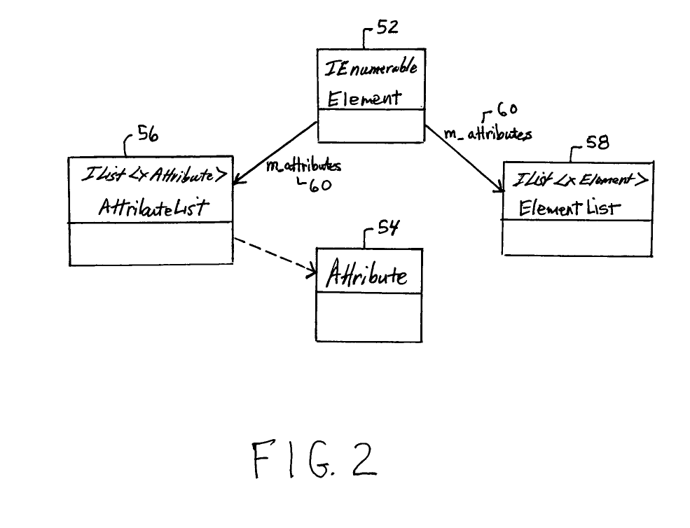

As shown in FIG. 2, an exemplary unified modeling language (UML) model 50 includes a static (i.e., non-dynamic or sequential) view of process 100. Model 50 is not intended to serve as a data flow, sequential, or interactive description of the process 100, only a snapshot of the entities included in process 100.

An “Element” entity 52 is stored in memory and is a main class abstraction for process 100 representing an XML element. A class is an abstract concept in programming and the square symbol with a line drawn through the middle is the UML syntax for a class. The Element class symbol has italic text “IEnumerable.” The position of this text within the symbol denotes that the term represents a programming interface. This means that the Element class supports the defined interface IEnumerable.

An interface includes a set of properties and functions (e.g., methods) and a well-defined behavior. IEnumerable is a programming interface defined by the .NET library. IEnumerable is supported and implemented by the Element class to enable all .NET languages to use Element with the specific language's enumeration support. Enumeration is an ability to traverse a sequential list of items using a programming syntax.

Element is the main class for process 100. Element includes a set of signatures that describe the properties and functions (e.g., methods) that the .NET programming languages use to manipulate XML data. Element is analogous to the XML construct “element.”

The “Attribute” entity 54 is stored in memory and is the main class abstraction for process 100 representing an XML attribute.

The Attribute entity includes two properties, i.e., a name representing the physical name of the attribute and a value representing the value of the attribute. Attribute objects, wherein an object is a runtime instance of a class which is an abstraction, are stored in an AttributeList entity.

The “AttributeList” entity 56 is stored in memory and is an abstraction for process 100 representing a list of XML attributes.

The AttributeList 54 class supports a IList< > generic interface that is defined by the .NET library. The IList interface is configured to contain only “xAttribute” objects. “xAttribute” is a runtime implementation of the Attribute class.

AttributeList 54 is always referenced within the Element class using a class variable called “m_Attributes.” This is usually denoted by a straight arrow line pointing from the Element class to the AttributeList class. The text “m_Attributes” near the line signifies the class variable referencing the AttributeList.

An “ElementList” entity 58 is stored in memory and is an abstraction for process 100 representing a list of XML elements.

The ElementList 58 class supports a IList< > generic interface that is defined by the .NET library. The IList interface is configured to contain only “xElement” objects. “xElement” is the runtime implementation of the Element class.

ElementList 58 is always referenced within the Element class using a class variable called “m_Elements” 60. This is denoted by the straight arrow line pointing from the Element class to the ElementList class. The text “m_Elements” 60 near the line signifies the class variable referencing the ElementList.

The entities Element 52, Attribute 54, ElementList 58, and AttributeList 56, and their properties, combine to parse XML documents into data structures required to implement process 100.

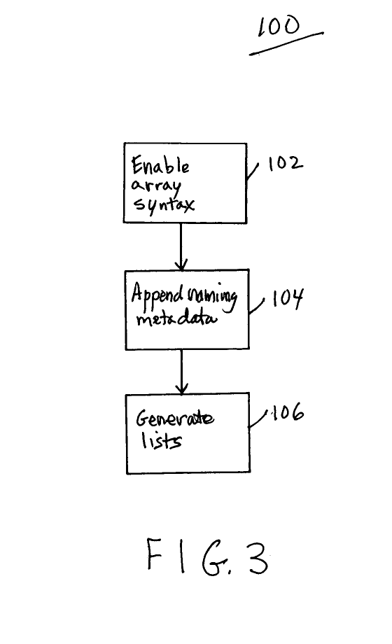

As shown in FIG. 3, process 100 includes enabling (102) an array syntax within an object-oriented programming language to retrieve data from an extensible markup language (XML) document. The array syntax can include defined object types, a tag name of an individual child element of a parent element object, and a name of a selected attribute within the tag name of the individual child element. In a particular example, the object-oriented programming language is .NET from Microsoft Corporation.

The array syntax can represented by a unified modeling language (UML) model including an element entity representing an XML element, an attribute entity representing an XML attribute, an attribute list entity representing a list of XML attributes, and an element list entity representing a list of XML elements.

The element entity includes a set of signatures that describe properties and functions that object-oriented programming languages use to manipulate XML data. The attribute entity includes a name representing a physical name of an attribute and a value representing a value of the attribute. The attribute list entity supports a ILIST< > generic interface that is define by a .NET library. The element list entity supports a ILIST< > generic interface that is define by a .NET library.

Process 100 appends (104) naming metadata as a governed sequence number to differentiate between duplicate element tag names. The governed sequence number within an element can include a value in a range 1 to a highest value of a signed 32-bit integer.

Process 100 generates (106) two lists of child elements for each parent element. A first list represents a sequential arrangement of elements in the received XML data. A second list includes a hash table for fast look-up using a qualified name.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A computer-implemented method comprising:
enabling an array syntax within an object-oriented programming language to retrieve data from an extensible markup language (XML) document, the array syntax comprising defined object types, a tag name of an individual child element of a parent element object, and a name of a selected attribute within the tag name of the individual child element.

2. The computer-implemented method of claim 1 wherein the object-oriented programming language is .NET.

3. The computer-implemented method of claim 1 further comprising appending naming metadata as a governed sequence number to differentiate between duplicate element tag names.

4. The computer-implemented method of claim 3 wherein the governed sequence number within a element comprises a value in a range 1 to a highest value of a signed 32-bit integer.

5. The computer-implemented method of claim 1 wherein the array syntax is represented by a unified modeling language (UML) model.

6. The computer-implemented method of claim 5 wherein the UML model comprises:
an element entity representing an XML element;
an attribute entity representing an XML attribute;
an attribute list entity representing a list of XML attributes; and
an element list entity representing a list of XML elements.

7. The computer-implemented method of claim 6 wherein the element entity comprises a set of signatures that describes properties and functions that the object-oriented programming language uses to manipulate XML data.

8. The computer-implemented method of claim 6 wherein the attribute entity comprises a name representing a physical name of an attribute and a value representing a value of the attribute.

9. The computer-implemented method of claim 6 wherein the attribute list entity supports a ILIST< > generic interface included in a .NET library.

10. The computer-implemented method of claim 6 wherein the element list entity supports a ILIST< > generic interface that is included in a .NET library.

11. A computer-implemented method comprising:
receiving and parsing extensible markup language (XML) data to an instantiated element object, the instantiated element object assuming a role of a parent element to a root element of the received XML data and returning the root element of the XML data as a newly instantiated element, the parsing including applying additional naming metadata to each element in a form of governed sequence numbers that qualify each child element within any given parent element.

12. The computer-implemented method of claim 111 further comprising organizing two lists of child elements for each parent element, a first list representing a sequential arrangement of elements in the received XML data and a second list comprising a hash table for fast look-up using a qualified name.

13. The computer-implemented method of claim 12 wherein the qualified name comprises an original element tag name and a governed sequence number.

14. The computer-implemented method of claim 13 wherein the governed sequence number comprises a value in a range 1 to a highest value of a signed 32-bit integer.

15. A computer program product, tangibly embodied in an information carrier, for accessing extensible markup language (XML) document data from Microsoft .NET framework programming languages using array lookup syntax, the computer program product being operable to cause data processing apparatus to:
receive and parse XML data to an instantiated element object, the instantiated element object assuming a role of a parent element to a root element of the received XML data and returning the root element of the XML data as a newly instantiated element, the parsing including applying additional naming metadata to each element in a form of governed sequence numbers that qualify each child element within any given parent element.

16. The computer program product of claim 15 further operable to cause data processing apparatus to:
organize two lists of child elements for each parent element, a first list representing a sequential arrangement of elements in the received XML data and a second list comprising a hash table for fast look-up using a qualified name.

17. The computer program product of claim 16 wherein the qualified name comprises an original element tag name and a governed sequence number.

18. The computer program product of claim 15 wherein the governed sequence number comprises a value in a range 1 to a highest value of a signed 32-bit integer.
